(19) United States
(12) Patent Application Publication
(10) Pub. No.: US 2026/0129384 A1
(43) Pub. Date: May 7, 2026

(54) METHODS FOR DETECTING WEARING POSITIONS OF EARPHONES, EARPHONES, AND ELECTRONIC DEVICES

(71) Applicant: SHENZHEN SHOKZ CO., LTD., Shenzhen (CN)

(72) Inventors: Libin ZHOU, Shenzhen (CN); Liang WANG, Shenzhen (CN)

(73) Assignee: SHENZHEN SHOKZ CO., LTD., Shenzhen (CN)

(21) Appl. No.: 19/436,058

(22) Filed: Dec. 30, 2025

Related U.S. Application Data
(63) Continuation of application No. PCT/CN2024/114796, filed on Aug. 27, 2024.

(51) Int. Cl. H04R 29/00; H04R 1/10

(52) U.S. Cl. CPC H04R 29/001; H04R 1/1041; H04R 1/1091

(57) ABSTRACT

Disclosed is a method for detecting a wearing position of an earphone, an earphone, and an electronic device. The earphone includes a detection module and stores a wearing position indication. The wearing position indication is used to indicate whether the earphone is worn on a left ear or a right ear. The detection method includes: obtaining a kinematic parameter of a wearer of the earphone by using the detection module; determining a motion state of the wearer according to the kinematic parameter; determining a corresponding update strategy according to the motion state; and updating the wearing position indication by using the kinematic parameter based on the corresponding update strategy. Different motion states correspond to different update strategies.

### CROSS REFERENCE TO RELATED APPLICATIONS

This application is a continuation of International Application No. PCT/CN 2024/114796 filed on Aug. 27, 2024, the entire contents of which are incorporated herein by reference.

### TECHNICAL FIELD

The present disclosure relates to the field of consumer electronics, and in particular, to a method for detecting a wearing position of an earphone, an earphone, and an electronic device.

### BACKGROUND

An earphone usually stores a wearing position indication. The wearing position indication is used to indicate whether the earphone is worn on a left ear or a right ear. The earphone may adapt an audio signal of a corresponding channel or set a key function of the earphone according to the stored wearing position indication. As such, how to improve the accuracy of the wearing position indication stored in the earphone becomes a technical problem to be solved urgently.

### SUMMARY

One or more embodiments of the present disclosure provide a method for detecting a wearing position of an earphone. The earphone includes a detection module and stores a wearing position indication. The wearing position indication is used to indicate whether the earphone is worn on a left ear or a right ear. The detection method includes: obtaining a kinematic parameter of a wearer of the earphone by using the detection module; determining a motion state of the wearer according to the kinematic parameter; determining a corresponding update strategy according to the motion state, and updating the wearing position indication by using the kinematic parameter based on the corresponding update strategy. Different motion states correspond to different update strategies.

In some embodiments, the greater a motion intensity of the wearer represented by the motion state is, the lower an update confidence of the kinematic parameter for the wearing position indication is set in the corresponding update strategy.

In some embodiments, the motion state includes a first motion state and a second motion state. A motion intensity represented by the first motion state is greater than a motion intensity represented by the second motion state. The determining the corresponding update strategy according to the motion state, and updating the wearing position indication by using the kinematic parameter based on the corresponding update strategy includes: in the first motion state, not updating the wearing position indication by using the kinematic parameter; in the second motion state, updating the wearing position indication by using the kinematic parameter.

In some embodiments, the first motion state corresponds to a running/jumping state of the wearer, and the second motion state corresponds to a walking state or a static state of the wearer.

In some embodiments, the determining the corresponding update strategy according to the motion state, and updating the wearing position indication by using the kinematic parameter based on the corresponding update strategy includes: periodically obtaining a preliminary determination result indicating the wearing position of the earphone by using the kinematic parameter according to a predetermined detection period, the preliminary determination result being used to indicate whether the earphone is worn on the left ear or the right ear; in a predetermined count of continuously set detection periods, determining a count value of preliminary determination results that are in a valid state and are different from the wearing position indication, the preliminary determination result in the valid state indicating that the earphone is worn on one of the left ear and the right ear; in response to the count value being greater than or equal to a preset count threshold, updating the wearing position indication to the preliminary determination result, the greater the motion intensity represented by the motion state is, the greater the preset count threshold is.

In some embodiments, the motion state includes a first motion state and a second motion state. A motion intensity represented by the first motion state is greater than a motion intensity represented by the second motion state. The preset count threshold in the first motion state is greater than the predetermined count. The preset count threshold in the second motion state is less than or equal to the predetermined count.

In some embodiments, the motion state further includes a third motion state. A motion intensity represented by the third motion state is less than the motion intensity represented by the second motion state. The preset count threshold in the third motion state is less than the preset count threshold in the second motion state.

In some embodiments, the first motion state corresponds to a running/jumping state of the wearer, the second motion state corresponds to a walking state of the wearer, and the third motion state corresponds to a static state of the wearer.

In some embodiments, the kinematic parameter includes an acceleration value. The determination of the motion state and the update of the wearing position indication are based on the acceleration value. Alternatively, the kinematic parameter includes an acceleration value and an angular velocity value. The determination of the motion state is based on at least one of the angular velocity value or the acceleration value. The update of the wearing position indication is based on the acceleration value and the angular velocity value.

In some embodiments, the detection method further includes: selectively enabling or disabling a touch function of the earphone in response to the motion state.

In some embodiments, in response to that the motion state corresponds to the static state or the walking state of the wearer, the touch function of the earphone is enabled; in response to that the motion state corresponds to the running/jumping state of the wearer, the touch function of the earphone is disabled.

One or more embodiments of the present disclosure provide an earphone. The earphone includes a processor and a memory. The memory stores a computer program. The processor is configured to execute the computer program to implement any one of the methods for detecting described above.

One or more embodiments of the present disclosure provide an electronic device. The electronic device is configured to be in communication with an earphone and includes a processor and a memory. The memory stores a computer program. The processor is configured to execute the computer program to implement any one of the methods for detecting described above.

In related technologies, a wearing position indication stored in an earphone is typically set only by an earphone case. When the earphone is taken out of the earphone case, the wearing position indication stored in the earphone does not change. Once a wearer does not wear the earphone according to a preset wearing manner, a situation in which the wearing position indication does not match an actual wearing position occurs, which affects a user experience. In the solution of the present disclosure, the kinematic parameter detected by the detection module may reflect the wearing position of the earphone. After the earphone is taken out of the earphone case, the wearing position indication may be updated by using the kinematic parameter, which is conducive to reducing a possibility that the wearing position indication does not match the actual wearing position, thereby improving accuracy of the wearing position indication.

On the other hand, fluctuation degrees of the kinematic parameter are different in different motion states. When the earphone is in a wearing state, the more intense the motion state of the wearer is, the greater the fluctuation degree of the kinematic parameter may be, and the lower the accuracy of the wearing position reflected by the kinematic parameter may be. Therefore, by setting different motion states corresponding to different update strategies, determining the motion state of the wearer according to the kinematic parameter, and selecting the corresponding update strategy based on the motion state, the accuracy of the wearing position indication is improved.

### BRIEF DESCRIPTION OF THE DRAWINGS

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to derive other drawings from these accompanying drawings without creative labor, wherein:

FIG. 1 is a diagram illustrating a state in which an earphone is worn on an ear of a wearer according to some embodiment of the present disclosure.

FIG. 2 is a schematic flowchart illustrating a detection method according to some embodiment of the present disclosure.

FIG. 3 is a schematic flowchart illustrating a detection method according to according to some embodiment of the present disclosure.

FIG. 4 is a schematic flowchart illustrating a process S300 according to some embodiment of the present disclosure.

FIG. 5 is a schematic flowchart illustrating a detection method according to some embodiment of the present disclosure.

FIG. 6 is a schematic block diagram illustrating an earphone according to some embodiment of the present disclosure.

FIG. 7 is a schematic block diagram illustrating an electronic device according to some embodiment of the present disclosure.

### DETAILED DESCRIPTION

The following describes the present disclosure in further detail with reference to the accompanying drawings and embodiments. It is specifically pointed out that the following embodiments are only used to illustrate the present disclosure but do not limit the scope of the present disclosure. Similarly, the following embodiments are only some embodiments of the present disclosure rather than all embodiments. All other embodiments obtained by a person of ordinary skill in the art based on the embodiments of the present disclosure without creative labor shall fall within the protection scope of the present disclosure.

In the present disclosure, reference to “an embodiment” means that a particular feature, structure, or characteristic described in connection with the embodiment may be included in at least one embodiment of the present disclosure. The phrase appearing in various places in the specification does not necessarily refer to the same embodiment, and is not an independent or alternative embodiment mutually exclusive with other embodiments. A person skilled in the art explicitly and implicitly understands that the embodiments described herein may be combined with other embodiments.

In the present disclosure, the terms “first,” “second,” and “third” are used for descriptive purposes only, and cannot be understood as indicating or implying relative importance or implicitly indicating the quantity of the indicated technical features. Thus, features defined with “first,” “second,” and “third” may explicitly or implicitly include at least one such feature. In the description of the present disclosure, the meaning of “a plurality of” is at least two, for example, two, three, etc., unless otherwise explicitly and specifically defined. The terms “include” and “have” and any variations thereof are intended to cover non-exclusive inclusion. For example, a process, method, system, product, or device that includes a series of steps or units is not limited to the listed steps or units, but optionally also includes steps or units that are not listed, or optionally also includes other steps or units inherent to such processes, methods, products, or devices.

In one aspect, the present disclosure provides a method for detecting a wearing position of an earphone. The method may be performed by the earphone itself, or may be performed by an electronic device in communication with the earphone. The electronic device may specifically be a mobile phone, a tablet, or a computer. The present disclosure does not impose limitations in this regard, and a person skilled in the art may make a selection based on actual requirements.

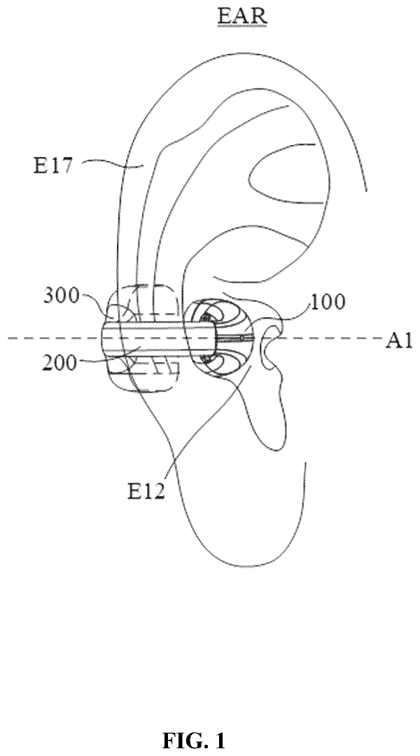

As shown in FIG. 1, FIG. 1 is a diagram illustrating a state in which an earphone is worn on an ear EAR of a wearer according to some embodiment of the present disclosure. The earphone may be an ear-clip earphone 1. As shown in FIG. 1, the earphone 1 includes a sound generation portion 100 for inserting into a concha cavity E12 of a wearer (a user), an abutting portion 300 for abutting behind an ear of the wearer, and an ear hook 200 connected between the sound generation portion 100 and the abutting portion 300. In a wearing state, the ear hook 200 may bypass a helix E17 of the wearer, and the sound generation portion 100 and the abutting portion 300 form a clamping state on two sides of the helix E17 of the user, with the sound generation portion 100 located in the concha cavity E12.

The sound generation portion 100 is a sound playback device, which is configured to convert an electrical signal into a sound signal and play the sound signal to the wearer. The abutting portion 300 and the sound generation portion 100 form the clamping state, so as to clamp the entire earphone 1 onto the ear of the user. A detection module and a storage module may be disposed in the abutting portion 300. The detection module is configured to obtain a kinematic parameter of the wearer of the earphone. The storage module is configured to store a wearing position indication, and the wearing position indication is used to indicate whether the earphone is worn on a left ear or a right ear.

In some embodiments, the detection module and the storage module may also be disposed in the sound generation portion 100, or one of the detection module and the storage module is disposed in the sound generation portion 100 and the other one is disposed in the abutting portion 300. The present disclosure does not impose limitations in this regard, and a person skilled in the art may make a selection based on actual requirements. In some embodiments, a battery, a circuit board, and other components may be disposed in the abutting portion 300. Certainly, the abutting portion 300 may not be provided with the battery, and the battery may be installed in the sound generation portion 100. This is within the scope easily understood by a person skilled in the art, and details are not described herein.

As shown in FIG. 1, the ear hook 200 has a symmetry plane A1 disposed along a length direction of the ear hook 200. Specifically, portions of the ear hook 200 on two sides of the symmetry plane A1 have a smallest difference or are consistent. That is, if the ear hook 200 is regularly symmetrical, the portions of the ear hook 200 on the two sides of the symmetry plane A1 are consistent. If the ear hook 200 is not strictly symmetrical, a difference between the portions of the ear hook 200 on the two sides of the symmetry plane A1 should be the smallest among various division manners. For example, a projection of the ear hook 200 may be observed on a plane perpendicular to the symmetry plane A1 to distinguish a size of the difference. When the earphone is in a relatively ideal wearing state, the symmetry plane A1 may be substantially parallel to a horizontal plane. It should be noted that “substantially parallel” described in the present disclosure allows an error range of plus or minus 15 degrees. It is easily understood that during use by the wearer, the earphone may slide under its own gravity, causing the symmetry plane A1 to deviate from the horizontal plane.

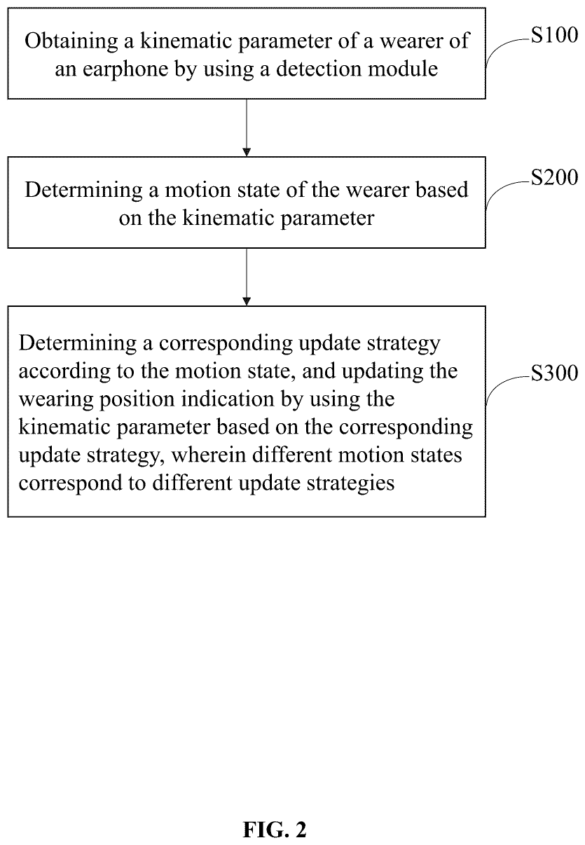

As shown in FIG. 2, FIG. 2 is a schematic flowchart illustrating a detection method according to some embodiment of the present disclosure. The detection method may specifically include the following operations.

In S100, a kinematic parameter of a wearer of an earphone is obtained by using a detection module.

In some embodiments, the detection module includes an acceleration sensor. Correspondingly, the kinematic parameter includes an acceleration value detected by the acceleration sensor.

For example, the acceleration sensor is provided with a built-in spatial coordinate system, including an X-axis, a Y-axis, and a Z-axis. The X-axis and the Y-axis may both be substantially parallel to the symmetry plane A1, and the Z-axis may be substantially perpendicular to the symmetry plane A1. It should be noted that “substantially parallel” and “substantially perpendicular” described in the present disclosure allow an error range of plus or minus 15 degrees. The acceleration sensor may detect acceleration values of the earphone in an X-axis direction, a Y-axis direction, and a Z-axis direction. Correspondingly, the kinematic parameter may include the acceleration values in the X-axis direction, the Y-axis direction, and the Z-axis direction.

In some embodiments, the detection module includes the acceleration sensor and a gyroscope. Correspondingly, the kinematic parameter includes the acceleration value detected by the acceleration sensor and an angular velocity value detected by the gyroscope.

For example, the gyroscope may share the same spatial coordinate system with the acceleration sensor, and is used to detect angular velocity values of the earphone rotating about the X-axis, rotating about the Y-axis, and rotating about the Z-axis. Correspondingly, the kinematic parameter may include the acceleration values in the X-axis direction, the Y-axis direction, and the Z-axis direction, and the angular velocity values rotating about the X-axis, rotating about the Y-axis, and rotating about the Z-axis.

In S200, a motion state of the wearer is determined based on the kinematic parameter.

In some embodiments, the motion state includes a first motion state and a second motion state. A motion intensity represented by the first motion state is greater than a motion intensity represented by the second motion state. The first motion state corresponds to a running/jumping state of the wearer, and the second motion state corresponds to a walking state or a static state of the wearer.

In some embodiments, the motion state includes a first motion state, a second motion state, and a third motion state. The motion intensity represented by the first motion state is greater than the motion intensity represented by the second motion state, and the motion intensity represented by the second motion state is greater than a motion intensity represented by the third motion state. The first motion state corresponds to the running/jumping state of the wearer, the second motion state corresponds to the walking state of the wearer, and the third motion state corresponds to the static state of the wearer.

In some embodiments, the detection module includes the acceleration sensor. Correspondingly, the kinematic parameter includes the acceleration value detected by the acceleration sensor. In this situation, S200 may include: inputting the acceleration values in the X-axis direction, the Y-axis direction, and the Z-axis direction into a first motion state determination algorithm, and the first motion state determination algorithm outputs the motion state of the wearer of the earphone based on the acceleration values, for example, the running/jumping state, the walking state, or the static state.

In some embodiments, a basic principle of the first motion state determination algorithm may be: performing a motion state determination by analyzing at least one of an overall parameter change magnitude, an overall parameter change rate, or an overall parameter fluctuation degree based on the acceleration values in the X-axis direction, the Y-axis direction, and the Z-axis direction.

In some embodiments, the motion state may be determined based on the overall parameter change magnitude. For example, a difference between a maximum amplitude and a minimum amplitude of an overall parameter may be used to represent the overall parameter change magnitude. In response to that the difference between the maximum amplitude and the minimum amplitude is greater than or equal to a first threshold, it is determined that the wearer is in the running/jumping state. In response to that the difference between the maximum amplitude and the minimum amplitude is greater than or equal to a second threshold and less than the first threshold, it is determined that the wearer is in the walking state. In response to that the difference between the maximum amplitude and the minimum amplitude is less than the second threshold, it is determined that the wearer is in the static state. The first threshold is greater than the second threshold.

In some embodiments, the motion state may be determined based on the overall parameter fluctuation degree. For example, a standard deviation of a plurality of overall parameters within a preset time period may be used to represent the overall parameter fluctuation degree. In response to that the standard deviation is greater than or equal to a third threshold, it is determined that the wearer is in the running/jumping state. In response to that the standard deviation is greater than or equal to a fourth threshold and less than the third threshold, it is determined that the wearer is in the walking state. In response to that the standard deviation is less than the fourth threshold, it is determined that the wearer is in the static state. The third threshold is greater than the fourth threshold.

In some embodiments, the motion state may be determined based on the overall parameter change rate. For example, a count of transitions of the overall parameter within a preset time period may be used to represent the overall parameter change rate. When the overall parameter decreases from the maximum amplitude to the minimum amplitude and then increases from the minimum amplitude to the maximum amplitude, it may be considered that one transition of the overall parameter occurs. In response to that the count of transitions within the preset time period is greater than or equal to a fifth threshold, it is determined that the wearer is in the running/jumping state. In response to that the count of transitions is greater than or equal to a sixth threshold and less than the fifth threshold, it is determined that the wearer is in the walking state. In response to that the count of transitions is less than the sixth threshold, it is determined that the wearer is in the static state. The fifth threshold is greater than the sixth threshold.

In some embodiments, other analysis algorithms may also be used to perform statistical calculations on the overall parameter and used to determine the motion state. This is within the scope easily understood by a person skilled in the art and will not be repeated here.

In some embodiments, the detection module includes the acceleration sensor and the gyroscope. Correspondingly, the kinematic parameter includes the acceleration value detected by the acceleration sensor and the angular velocity value detected by the gyroscope. In this situation, S200 may include: inputting the acceleration values in the X-axis direction, the Y-axis direction, and the Z-axis direction into the first motion state determination algorithm. The first motion state determination algorithm outputs the motion state of the wearer of the earphone based on the respective acceleration values, such as the running/jumping state, the walking state, or the static state.

Alternatively, S200 may include: inputting the angular velocity values rotating about the X-axis, rotating about the Y-axis, and rotating about the Z-axis into a second motion state determination algorithm. The second motion state determination algorithm outputs the motion state of the wearer of the earphone based on the respective angular velocity values, such as the running/jumping state, the walking state, or the static state. A basic principle of the second motion state determination algorithm may be: performing a motion state determination by analyzing at least one of an overall parameter change magnitude, an overall parameter change rate, or an overall parameter fluctuation degree based on the angular velocity values rotating about the X-axis, rotating about the Y-axis, and rotating about the Z-axis. The basic principle of the second motion state determination algorithm may be similar to the basic principle of the first motion state determination algorithm described above. This is within the scope easily understood by a person skilled in the art and will not be repeated here.

Alternatively, S200 may include: inputting both the acceleration values in the X-axis direction, the Y-axis direction, and the Z-axis direction and the angular velocity values rotating about the X-axis, rotating about the Y-axis, and rotating about the Z-axis into a third motion state determination algorithm. The third motion state determination algorithm outputs the motion state of the wearer of the earphone based on the respective acceleration values and the respective angular velocity values, such as the running/jumping state, the walking state, or the static state. This is within the scope easily understood by a person skilled in the art and will not be repeated here.

As analyzed above, the “overall parameter change magnitude” may be used to reflect the “motion intensity” of the wearer, the “overall parameter change rate” may also be used to reflect the “motion intensity” of the wearer, and the “overall parameter fluctuation degree” may also be used to reflect the “motion intensity” of the wearer. From a macro perspective, the “motion intensity” may be affected by at least one of the following factors: a motion amplitude change magnitude, a motion amplitude change rate, and a motion fluctuation degree.

In S300: a corresponding update strategy is determined according to the motion state, and the wearing position indication is updated by using the kinematic parameter based on the corresponding update strategy. Different motion states correspond to different update strategies.

Specifically, the kinematic parameter may be used to obtain a preliminary determination result indicating a wearing position of the earphone, and then the preliminary determination result may be used to update the wearing position indication, where the preliminary determination result is used to indicate whether the earphone is worn on the left ear or the right ear.

In some embodiments, the detection module includes the acceleration sensor. Correspondingly, the kinematic parameter includes the acceleration value detected by the acceleration sensor. In this situation, the acceleration values in the X-axis direction, the Y-axis direction, and the Z-axis direction detected by the acceleration sensor may be used to obtain the preliminary determination result. For example, the acceleration values in the X-axis direction, the Y-axis direction, and the Z-axis direction may be input into a trained neural network model, and the neural network model may generate the preliminary determination result after operations such as convolution and pooling.

When it is determined based on the acceleration values in the X-axis direction, the Y-axis direction, and the Z-axis direction that the earphone is worn on the left ear, the preliminary determination result may be set to indicate the left ear. When it is determined based on the acceleration values in the X-axis direction, the Y-axis direction, and the Z-axis direction that the earphone is worn on the right ear, the preliminary determination result may be set to indicate the right ear. When the wearing position of the earphone is not determined based on the acceleration values in the X-axis direction, the Y-axis direction, and the Z-axis direction, the preliminary determination result may be set to indicate an unknown state. When the preliminary determination result is set to indicate the left ear or the right ear, the preliminary determination result may be considered valid (i.e., in a valid state). When the preliminary determination result is set to indicate the unknown state, the preliminary determination result may be considered invalid (i.e., in an invalid state).

In some embodiments, the detection module includes the acceleration sensor and the gyroscope. Correspondingly, the kinematic parameter includes the acceleration value detected by the acceleration sensor and the angular velocity value detected by the gyroscope. In this situation, the acceleration values in the X-axis direction, the Y-axis direction, and the Z-axis direction detected by the acceleration sensor may be used to obtain the preliminary determination result, and when the preliminary determination result is in the invalid state, the gyroscope may be used to assist in determining the wearing position of the earphone.

For example, when the preliminary determination result is in the invalid state, the angular velocity value detected by the gyroscope when the wearer performs a preset head motion may be used to determine whether the earphone is worn on the left ear or the right ear, and the preliminary determination result may be reset to the valid state, which is beneficial for improving the validity of the preliminary determination result and thereby beneficial for improving the accuracy of the wearing position indication.

The preset head motion may include an action of tilting a head to a left shoulder, an action of tilting the head to a right shoulder, an action of turning the head to the left, an action of turning the head to the right, an action of raising the head upward, or an action of lowering the head downward. The present disclosure does not impose limitations in this regard, and a person skilled in the art may make a selection based on actual requirements When the preliminary determination result is in the invalid state, a voice reminder may be sent to the wearer to remind the wearer to perform the preset head motion, or other forms of reminders may also be sent to the wearer to cause the wearer to perform the preset head motion. The present disclosure does not impose limitations in this regard, and a person skilled in the art may make a selection based on actual requirements

In related technologies, a wearing position indication stored in an earphone is typically set only by an earphone case. When the earphone is taken out of the earphone case, the wearing position indication stored in the earphone does not change. Once a wearer does not wear the earphone according to a preset wearing manner, a situation in which the wearing position indication does not match an actual wearing position occurs, which affects a user experience. In the solution of the present disclosure, the kinematic parameter detected by the detection module may reflect the wearing position of the earphone. After the earphone is taken out of the earphone case, the wearing position indication may be updated by using the kinematic parameter, which is conducive to reducing a possibility that the wearing position indication does not match the actual wearing position, thereby improving accuracy of the wearing position indication.

On the other hand, fluctuation degrees of the kinematic parameter are different in different motion states. When the earphone is in a wearing state, the more intense the motion state of the wearer is, the greater the fluctuation degree of the kinematic parameter may be, and the lower the accuracy of the wearing position reflected by the kinematic parameter may be. Therefore, by setting different motion states corresponding to different update strategies, determining the motion state of the wearer according to the kinematic parameter, and selecting the corresponding update strategy based on the motion state, the accuracy of the wearing position indication is improved.

Specifically, the fluctuation degrees of the kinematic parameter are different under different motion states. The greater the fluctuation degree of the kinematic parameter is, the lower the accuracy of the preliminary determination result obtained based on the kinematic parameter may be. Therefore, when the earphone is in a wearing state, the more intense the motion state of the wearer is, the higher the possibility that the preliminary determination result does not match the actual wearing position may be. By setting different motion states corresponding to different update strategies, the accuracy of the wearing position indication is improved, the switching of the earphone back and forth when the credibility of the preliminary determination result is low is reduced, and the user experience of the wearer is improved.

In some embodiments, the greater the motion intensity represented by the motion state of the wearer is, the lower the update confidence of the kinematic parameter for the wearing position indication set in the corresponding update strategy may be.

The update confidence of the kinematic parameter for the wearing position indication refers to a credibility degree of the wearing position reflected by the kinematic parameter, that is, a credibility degree of the preliminary determination result. The more intense the motion state of the wearer is, the greater the fluctuation degree of the kinematic parameter may be, and the lower the credibility degree of the preliminary determination result may be.

For example, the motion state may include the first motion state and the second motion state. The motion intensity represented by the first motion state may be greater than the motion intensity represented by the second motion state. In this situation, a credibility degree of the preliminary determination result in the first motion state is lower than a credibility degree of the preliminary determination result in the second motion state.

As another example, the motion state may include the first motion state, the second motion state, and the third motion state. The motion intensity represented by the first motion state is greater than the motion intensity represented by the second motion state, and the motion intensity represented by the second motion state is greater than the motion intensity represented by the third motion state. In this situation, credibility degrees of the preliminary determination result sequentially increases in the first motion state, the second motion state, and the third motion state.

In some embodiments, S300 may be implemented by the following operations: periodically obtaining the preliminary determination result by using the kinematic parameter; determining a count value of preliminary determination results that are in the valid state and are different from the wearing position indication in ten consecutive detection periods; and in response to the count value being greater than or equal to a preset count threshold, updating the wearing position indication to the preliminary determination result. In this situation, the credibility degree of the preliminary determination result may be directly reflected in a size of the preset count threshold. The greater the motion intensity represented by the motion state is, the lower the credibility degree of the preliminary determination result may be, and the larger the preset count threshold may be.

In some embodiments, S300 may be implemented by the following operations: in the running/jumping state, setting the credibility degree of the preliminary determination result to 0, that is, the preliminary determination result is not used to update the wearing position indication. In the walking state or the static state, setting the credibility degree of the preliminary determination result to 1, and directly using the preliminary determination result to update the wearing position indication after the detection module obtains the preliminary determination result.

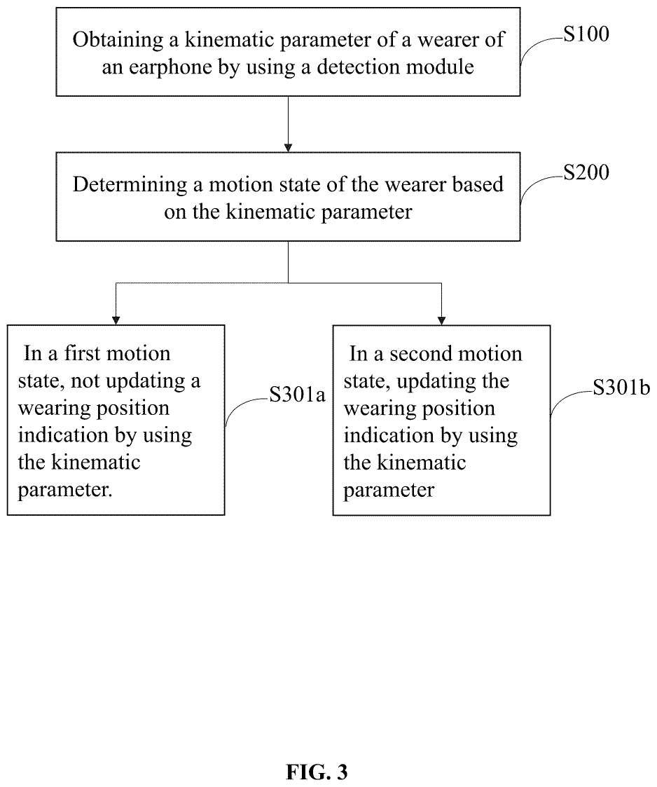

As shown in FIG. 3, FIG. 3 is a schematic flowchart illustrating a detection method according to according to some embodiment of the present disclosure. In some embodiments, the first motion state corresponds to the running/jumping state of the wearer, and the second motion state corresponds to the walking state or the static state of the wearer. S300 may include:

In S301a, in the first motion state, the wearing position indication is not updated by using the kinematic parameter.

When the wearer is in an intense motion state, for example, in the running/jumping state, the kinematic parameter detected by the detection module is not capable of accurately reflecting the wearing position of an earphone, that is, the accuracy of the preliminary determination result obtained by using the kinematic parameter is relatively low. Therefore, when it is determined that the wearer is in the first motion state, the wearing position indication is not updated by using the kinematic parameter, which is beneficial for improving the accuracy of the wearing position indication and reducing the power consumption of the device itself.

In some embodiments, in response to that the wearer is in the first motion state, the kinematic parameter may no longer be used to obtain the preliminary determination result that indicates the wearing position of the earphone, thereby no longer updating the wearing position indication. In some embodiments, in response to that the wearer is in the first motion state, the kinematic parameter may also be used to obtain the preliminary determination result that indicates the wearing position of the earphone, but the preliminary determination result is not used to update the wearing position indication. The present disclosure does not impose limitations in this regard, and a person skilled in the art may make a selection based on actual requirements.

In S301b, in the second motion state, the wearing position indication is updated by using the kinematic parameter.

When the wearer is in a non-intense motion state, for example, the walking state or the static state, the kinematic parameter detected by the detection module may relatively accurately reflect the wearing position of the earphone. That is, the accuracy of the preliminary determination result obtained by using the kinematic parameter is relatively high. Therefore, in response to that the wearer is in the second motion state, updating the wearing position indication by using the kinematic parameter is beneficial for improving the accuracy of the wearing position indication.

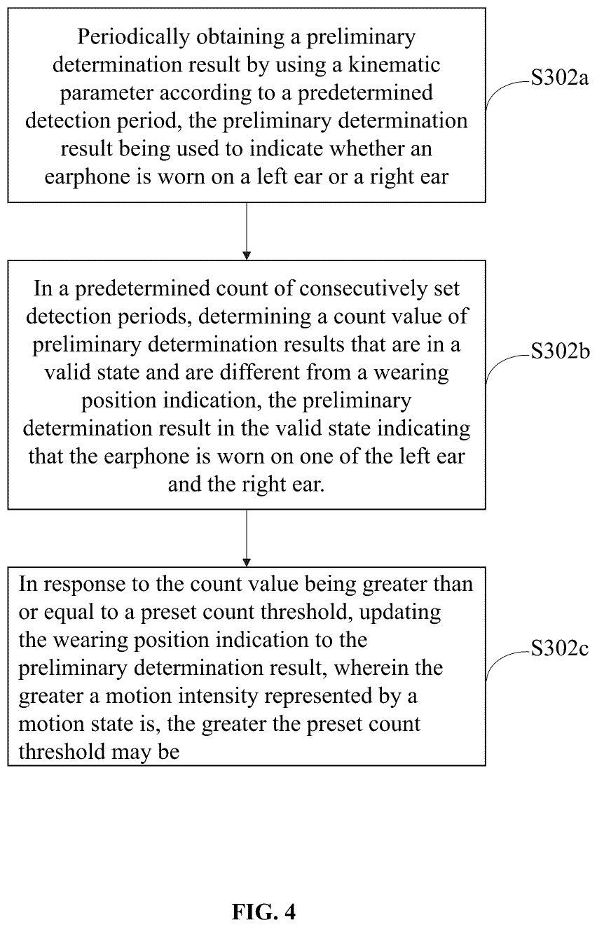

As shown in FIG. 4, FIG. 4 is a schematic flowchart illustrating a process S300 according to some embodiment of the present disclosure. In some embodiments, S300 may include:

In S302a, the preliminary determination result is periodically obtained by using the kinematic parameter according to a predetermined detection period. The preliminary determination result is used to indicate whether the earphone is worn on the left ear or the right ear.

Each detection period corresponds to generation of one preliminary determination result. The detection period may be between 50 ms and 10 s. For example, the detection period may be 50 ms, 100 ms, 300 ms, 500 ms, 1 s, 3 s, 5 s, or 10 s.

In S302b, in a predetermined count of consecutively set detection periods, the count value of preliminary determination results that are in the valid state and are different from the wearing position indication is determined. The preliminary determination result in the valid state indicates that the earphone is worn on one of the left ear and the right ear.

In S302c, in response to the count value being greater than or equal to the preset count threshold, the wearing position indication is updated to the preliminary determination result. The greater the motion intensity represented by the motion state is, the greater the preset count threshold may be.

For example, the predetermined count may be 10. That is, “the predetermined count of consecutively set detection periods” may refer to 10 consecutively set detection periods. The present disclosure does not impose limitations in this regard, and a person skilled in the art may make a selection based on actual requirements.

As described above, the motion state may include the first motion state and the second motion state. The motion intensity represented by the first motion state may be greater than the motion intensity represented by the second motion state. A preset count threshold in the first motion state is greater than a preset count threshold in the second motion state.

In some embodiments, the preset count threshold in the first motion state and the preset count threshold in the second motion state are both less than or equal to the aforementioned predetermined count.

For example, the preset count threshold in the first motion state may be equal to 10. Assuming that the current wearing position indication indicates the wearing position as the left ear, if the preliminary determination results in 10 consecutively set detection periods are all the right ear, then the wearing position indication is updated from the left ear to the right ear. If, in the 10 consecutive detection periods, the preliminary determination result in at least one period is the left ear, then the wearing position indication is not updated.

Correspondingly, the preset count threshold in the update strategy corresponding to the second motion state may be less than 10 (e.g., 6). For example, assuming that the current wearing position indication indicates the wearing position as the left ear, if, in 10 consecutively set detection periods, a count of periods in which the preliminary determination result is the right ear is greater than or equal to 6, then the wearing position indication is updated from the left ear to the right ear. If, in the 10 consecutive detection periods, the count of periods in which the preliminary determination result is the right ear is less than 6, then the wearing position indication is not updated.

In some embodiments, the preset count threshold in the first motion state is greater than the aforementioned predetermined count, and the preset count threshold in the second motion state is less than or equal to the aforementioned predetermined count.

For example, the preset count threshold in the first motion state may be 11. The preset count threshold of 11 in the first motion state is greater than the predetermined count of 10. That is, in response to that the wearer is in the first motion state, the wearing position indication is not updated, which is beneficial for improving the accuracy of the wearing position indication.

Correspondingly, the preset count threshold in the update strategy corresponding to the second motion state may be less than or equal to 10 (e.g., 9). For example, assuming that the current wearing position indication indicates the wearing position as the left ear, if, in 10 consecutively set detection periods, a count of periods in which the preliminary determination result is the right ear is greater than or equal to 9, then the wearing position indication is updated from the left ear to the right ear. If, in the 10 consecutive detection periods, the count of periods in which the preliminary determination result is the right ear is less than 9, then the wearing position indication is not updated.

As described above, in some embodiments, the motion state includes the first motion state, the second motion state, and the third motion state. The motion intensities represented by the first motion state, the second motion state, and the third motion state decrease sequentially. The first motion state corresponds to the running/jumping state of the wearer, the second motion state corresponds to the walking state of the wearer, and the third motion state corresponds to the static state of the wearer. In this situation, the preset count thresholds in the first motion state, the second motion state, and the third motion state decrease sequentially.

For example, the predetermined count may be 10, the preset count threshold in the first motion state may be 11, the preset count threshold in the second motion state may be 9, and the preset count threshold in the third motion state may be 6. As another example, the predetermined count may be 10, the preset count threshold in the first motion state may be 10, the preset count threshold in the second motion state may be 9, and the preset count threshold in the third motion state may be 6. The present disclosure does not impose limitations in this regard, and a person skilled in the art may make a selection based on actual requirements.

In some embodiments, the operations in S300 of updating the wearing position indication by using the kinematic parameter based on the corresponding update strategy is performed in real time within a preset time period. For example, in response to the earphone being in a wearing state, timing is started. Within the preset time period (e.g., a duration of the preset time period may be between 20 s and 60 s, such as 20 s, 30 s, 40 s, 50 s, or 60 s), the wearing position indication is updated in real time by using the kinematic parameter based on the corresponding update strategy.

Due to different wearing positions of the earphone, different postures of the wearer, or influences of other factors, the detection module may incorrectly identify the left and right ears during an initial detection process. For example, in a semi-reclining state, the accuracy rate of the preliminary determination result is relatively low, causing the wearing position indication to be inconsistent with an actual wearing position of the earphone. In this situation, if the posture of the wearer is adjusted back, or the wearing position of the earphone is adjusted, the detection module may obtain a correct preliminary determination result during a subsequent detection process. After updating the wearing position indication, a previous incorrect state may be corrected, which is beneficial for improving the accuracy of the wearing position indication and improving the user experience of the wearer.

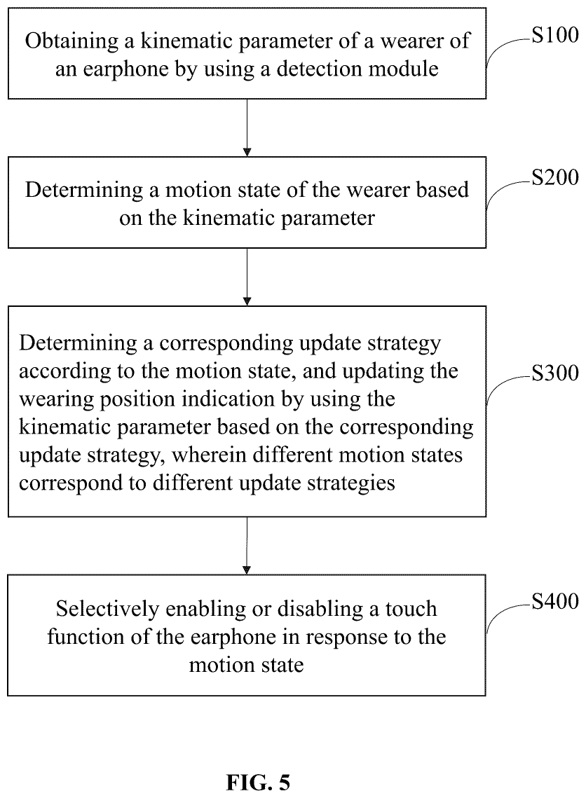

As shown in FIG. 5, FIG. 5 is a schematic flowchart illustrating a detection method according to some embodiment of the present disclosure. In some embodiments, the detection method further includes:

In S400, in response to the motion state, a touch function of the earphone is selectively enabled or disabled.

Specifically, the earphone may be provided with a physical button or a virtual button for receiving a touch operation from the wearer. When the wearer is in the intense motion state, such as the running/jumping state, the possibility of performing a touch operation on the physical button or the virtual button on the earphone is relatively small, and accidental touch is more likely to occur. For example, the hair of the wearer may cause an accidental touch on the physical button or the virtual button. When the wearer is in the non-intense motion state, such as the walking state or the static state, it is possible to perform the touch operation on the physical button or the virtual button on the earphone, and the possibility of the accidental touch is relatively small.

S400 may be implemented by the following operations:

In S401, in response to that the motion state corresponds to the static state or the walking state of the wearer, the touch function of the earphone is enabled.

As analyzed above, when the wearer is in the walking state or the static state, it is possible to perform the touch operation on the physical button or the virtual button on the earphone, and the possibility of the accidental touch is relatively small. In this situation, the touch function of the earphone may be enabled to facilitate the wearer to control the earphone according to actual requirements.

In S402, in response to that the motion state corresponds to the running/jumping state of the wearer, the touch function of the earphone is disabled.

As analyzed above, when the wearer is in the running/jumping state, the possibility of performing the touch operation on the physical button or the virtual button on the earphone is relatively small, and the accidental touch is more likely to occur. Therefore, in response to that the wearer is in the running/jumping state, the touch function of the earphone may be disabled, thereby avoiding the accidental touch and improving the user experience of the wearer.

It should be noted that, in some embodiments, S300 and S400 may be executed simultaneously. In some embodiments, S300 may also be executed after S400. The present disclosure does not impose limitations in this regard, and a person skilled in the art may make a selection based on actual requirements.

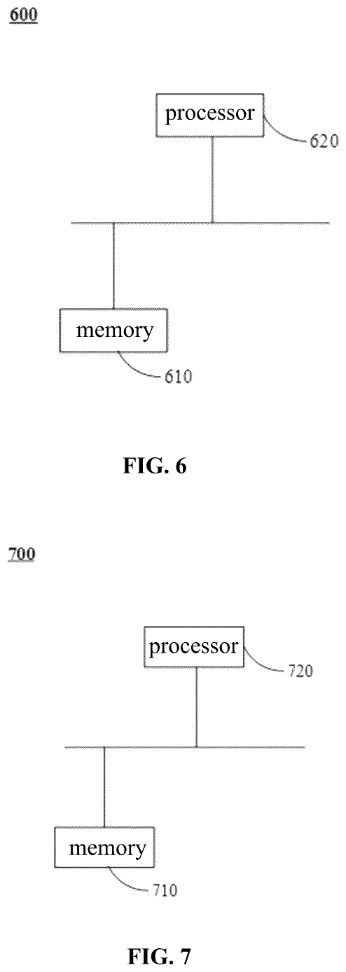

Another aspect of the present disclosure further provides an earphone 600. As shown in FIG. 6, FIG. 6 is a schematic block diagram illustrating an earphone according to some embodiment of the present disclosure. The earphone 600 includes a memory 610, a processor 620, and a computer program stored in the memory 610 and executable on the processor 620. The processor 620, when executing the computer program, implements any of the methods for detecting described above.

The processor 620 may also be referred to as a central processing unit (CPU). The processor 620 may be an integrated circuit chip with signal processing capability. The processor 620 may also be a general-purpose processor, a digital signal processor (DSP), an application-specific integrated circuit (ASIC), a field-programmable gate array (FPGA) or other programmable logic device, discrete gate or transistor logic device, or discrete hardware component. The general-purpose processor may be a microprocessor, or the processor 620 may be any conventional processor, etc.

The memory 610 may include a random access memory (RAM), a read-only memory (ROM), a flash memory, an erasable programmable read-only memory (EPROM), an electrically erasable programmable read-only memory (EEPROM), a register, a hard disk, a removable disk, a CD-ROM, etc. The memory 610 may store program data. The program data may, for example, include a single instruction or a plurality of instructions, and may be distributed across several different code segments, across different programs, and across a plurality of memories. The memory 610 may be coupled to the processor 620 such that the processor 620 may read/write information from/to the memory 610. The present disclosure does not impose limitations in this regard, and a person skilled in the art may make a selection based on actual requirements.

Another aspect of the present disclosure further provides an electronic device 700. As shown in FIG. 7, FIG. 7 is a schematic block diagram illustrating an electronic device according to some embodiment of the present disclosure. The electronic device 700 includes a memory 710, a processor 720, and a computer program stored in the memory 710 and executable on the processor 720. The processor 720, when executing the computer program, implements any of the methods for detecting described above.

The electronic device 700 may specifically be a mobile phone, a tablet, or a computer in communication with the earphone 800. The present disclosure does not impose limitations in this regard, and a person skilled in the art may make a selection based on actual requirements.

The processor 720 may also be referred to as a CPU. The processor 720 may be an integrated circuit chip having signal processing capability. The processor 720 may also be a general-purpose processor, a digital signal processor (DSP), an application-specific integrated circuit (ASIC), a field-programmable gate array (FPGA) or other programmable logic device, discrete gate or transistor logic device, or discrete hardware component. The general-purpose processor may be a microprocessor, or the processor 720 may be any conventional processor, etc.

The memory 710 may include a random access memory (RAM), a read-only memory (ROM), a flash memory, an erasable programmable read-only memory (EPROM), an electrically erasable programmable read-only memory (EEPROM), a register, a hard disk, a removable disk, a CD-ROM, etc. The memory 710 may store program data. The program data may, for example, include a single instruction or a plurality of instructions, and may be distributed across several different code segments, across different programs, and across multiple memories. The memory 710 may be coupled to the processor 720 such that the processor 720 can read/write information from/to the memory 710. The memory 710 may be integrated into the processor 720. The present disclosure does not impose limitations in this regard, and a person skilled in the art may make a selection based on actual requirements.

In the several embodiments provided in the present disclosure, it should be understood that the disclosed detection method may be implemented in other manners. Merely by way of example, the earphone/electronic device embodiments described above are merely illustrative. As another example, the division of modules or units is merely a logical function division. In actual implementation, there may be another division manner. For example, a plurality of units or components may be combined or integrated into another system, or some features may be omitted or not performed. As another point, the mutual coupling or direct coupling or communication connection shown or discussed may be an indirect coupling or communication connection through some interfaces, devices, or units, and may be in an electrical, mechanical, or other form.

The units described as separate components may or may not be physically separate. The components displayed as units may or may not be physical units, i.e., may be located in one place, or may be distributed to a plurality of network units. Some or all of the units may be selected according to actual requirements to achieve the objectives of the solutions of the present embodiment.

In addition, the functional units in the various embodiments of the present disclosure may be integrated into one processing unit, or each unit may exist alone physically, or two or more units may be integrated into one unit. The above integrated unit may be implemented in the form of hardware, or may be implemented in the form of a software functional unit.

The above descriptions are only some embodiments of the present disclosure, and are not intended to limit the scope of protection of the present disclosure. Any equivalent device or equivalent process transformation made by using the content of the specification and drawings of the present disclosure, or directly or indirectly applied in other related technical fields, shall similarly fall within the patent protection scope of the present disclosure.

1. A method for detecting a wearing position of an earphone, wherein the earphone is provided with a detection module and stores a wearing position indication, the wearing position indication being used to indicate whether the earphone is worn on a left ear or a right ear, the method comprising:
obtaining a kinematic parameter of a wearer of the earphone by using the detection module;
determining a motion state of the wearer according to the kinematic parameter; and
determining a corresponding update strategy according to the motion state, and updating the wearing position indication by using the kinematic parameter based on the corresponding update strategy, wherein different motion states correspond to different update strategies.

2. The method of claim 1, wherein the greater a motion intensity of the wearer represented by the motion state is, the lower an update confidence of the kinematic parameter for the wearing position indication is set in the corresponding update strategy.

3. The method of claim 2, wherein
the motion state comprises a first motion state and a second motion state, and a motion intensity represented by the first motion state is greater than a motion intensity represented by the second motion state; and
the determining the corresponding update strategy according to the motion state, and updating the wearing position indication by using the kinematic parameter based on the corresponding update strategy comprises:
in the first motion state, not updating the wearing position indication by using the kinematic parameter; and
in the second motion state, updating the wearing position indication by using the kinematic parameter.

4. The method of claim 3, wherein
the first motion state corresponds to a running/jumping state of the wearer; and
the second motion state corresponds to a walking state or a static state of the wearer.

5. The method of claim 2, wherein the determining the corresponding update strategy according to the motion state, and updating the wearing position indication by using the kinematic parameter based on the corresponding update strategy comprises:
periodically obtaining a preliminary determination result indicating the wearing position of the earphone by using the kinematic parameter according to a predetermined detection period, wherein the preliminary determination result is used to indicate whether the earphone is worn on the left ear or the right ear;
in a predetermined count of continuously set detection periods, determining a count value of preliminary determination results that are in a valid state and are different from the wearing position indication, wherein the preliminary determination result in the valid state indicates that the earphone is worn on one of the left ear and the right ear; and
in response to the count value being greater than or equal to a preset count threshold, updating the wearing position indication to the preliminary determination result, wherein the greater the motion intensity represented by the motion state is, the greater the preset count threshold is.

6. The method of claim 5, wherein the motion state comprises a first motion state and a second motion state, a motion intensity represented by the first motion state being greater than a motion intensity represented by the second motion state, wherein the preset count threshold in the first motion state is greater than the predetermined count, and the preset count threshold in the second motion state is less than or equal to the predetermined count.

7. The method of claim 5, wherein the motion state further comprises a third motion state, a motion intensity represented by the third motion state being less than the motion intensity represented by the second motion state, wherein the preset count threshold in the third motion state is less than the preset count threshold in the second motion state.

8. The method of claim 7, wherein
the first motion state corresponds to a running/jumping state of the wearer;
the second motion state corresponds to a walking state of the wearer; and
the third motion state corresponds to a static state of the wearer.

9. The method of claim 1, wherein
the kinematic parameter comprises an acceleration value, wherein the determination of the motion state and the update of the wearing position indication are based on the acceleration value; or
the kinematic parameter comprises an acceleration value and an angular velocity value, wherein the determination of the motion state is based on at least one of the angular velocity value or the acceleration value, and the update of the wearing position indication is based on the acceleration value and the angular velocity value.

10. The method of claim 1, wherein the method further comprises:
selectively enabling or disabling a touch function of the earphone in response to the motion state.

11. The method of claim 10, wherein
in response to that the motion state corresponds to the static state or the walking state of the wearer, enabling the touch function of the earphone; and
in response to that the motion state corresponds to the running/jumping state of the wearer, disabling the touch function of the earphone.

12. An earphone, comprising a processor and a memory, wherein a computer program is stored in the memory, and the processor is configured to execute the computer program to implement a method, comprising:
obtaining a kinematic parameter of a wearer of the earphone;
determining a motion state of the wearer according to a kinematic parameter; and
determining a corresponding update strategy according to the motion state, and updating the wearing position indication by using the kinematic parameter based on the corresponding update strategy, wherein different motion states correspond to different update strategies.

13. An electronic device, in communication with an earphone and comprising a processor and a memory, wherein a computer program is stored in the memory, and the processor is configured to execute the computer program to implement a method, comprising:
obtaining a kinematic parameter of a wearer of the earphone;
determining a motion state of the wearer according to a kinematic parameter; and
determining a corresponding update strategy according to the motion state, and updating the wearing position indication by using the kinematic parameter based on the corresponding update strategy, wherein different motion states correspond to different update strategies.

14. The method of claim 12, wherein the greater a motion intensity of the wearer represented by the motion state is, the lower an update confidence of the kinematic parameter for the wearing position indication is set in the corresponding update strategy.

15. The method of claim 14, wherein
the motion state comprises a first motion state and a second motion state, and a motion intensity represented by the first motion state is greater than a motion intensity represented by the second motion state; and
the determining the corresponding update strategy according to the motion state, and updating the wearing position indication by using the kinematic parameter based on the corresponding update strategy comprises:
in the first motion state, not updating the wearing position indication by using the kinematic parameter; and
in the second motion state, updating the wearing position indication by using the kinematic parameter.

16. The method of claim 15, wherein
the first motion state corresponds to a running/jumping state of the wearer; and
the second motion state corresponds to a walking state or a static state of the wearer.

17. The method of claim 14, wherein the determining the corresponding update strategy according to the motion state, and updating the wearing position indication by using the kinematic parameter based on the corresponding update strategy comprises:
periodically obtaining a preliminary determination result indicating the wearing position of the earphone by using the kinematic parameter according to a predetermined detection period, wherein the preliminary determination result is used to indicate whether the earphone is worn on the left ear or the right ear;
in a predetermined count of continuously set detection periods, determining a count value of preliminary determination results that are in a valid state and are different from the wearing position indication, wherein the preliminary determination result in the valid state indicates that the earphone is worn on one of the left ear and the right ear; and
in response to the count value being greater than or equal to a preset count threshold, updating the wearing position indication to the preliminary determination result, wherein the greater the motion intensity represented by the motion state is, the greater the preset count threshold is.

18. The method of claim 17, wherein the motion state comprises a first motion state and a second motion state, a motion intensity represented by the first motion state being greater than a motion intensity represented by the second motion state, wherein the preset count threshold in the first motion state is greater than the predetermined count, and the preset count threshold in the second motion state is less than or equal to the predetermined count.

19. The method of claim 17, wherein the motion state further comprises a third motion state, a motion intensity represented by the third motion state being less than the motion intensity represented by the second motion state, wherein the preset count threshold in the third motion state is less than the preset count threshold in the second motion state.

20. The method of claim 19, wherein
the first motion state corresponds to a running/jumping state of the wearer;
the second motion state corresponds to a walking state of the wearer; and
the third motion state corresponds to a static state of the wearer.
